(19) United States
(12) Patent Application Publication
(10) Pub. No.: US 2011/0215942 A1
(43) Pub. Date: Sep. 8, 2011

(54) LADDER POSITION INDICATOR LIGHT MODULE

(76) Inventors: Christopher Alan Cockrell, Provo, UT (US); Christopher James Wilderotter, Livermore, CA (US); Aaron Ray Drumright, Winters, CA (US)

(21) Appl. No.: 12/965,816

(22) Filed: Dec. 10, 2010

Related U.S. Application Data
(60) Provisional application No. 61/285,523, filed on Dec. 10, 2009.

(51) Int. Cl. G08B 21/00

(52) U.S. Cl. 340/689

(57) ABSTRACT

A flasher module, installable on a ladder, incorporates multiple high-intensity light-emitting diodes (LEDs), which are coupled to an electro-chemical power source (battery or single cell). The LEDs may be wired for a continuous “ON” condition, but are preferably connected to flasher circuitry. For maximum visible intensity, the flasher circuitry is designed so that all LEDs flash simultaneously about one to two times per second. A first embodiment flasher module is sized to install within the uppermost portion of a ladder rail of C-shaped cross section. A second embodiment module, which provides a larger viewing angle, incorporates the LEDs within a bar that is mountable beneath the uppermost rung of the ladder. Either embodiment of the invention may be equipped with a gravity-actuated switch, which will turn on the flasher circuitry whenever the ladder is deployed at an angle greater than 45 degrees from horizontal.

This application has a priority date based on the filing of Provisional Patent Application No. 61/285,523, titled LADDER POSITION INDICATOR LIGHT MODULE, on Dec. 10, 2009.

### BACKGROUND OF THE INVENTION

1. Field of the Invention

This invention relates, generally, to flashing light modules and, more particularly, to a flashing light module designed to mount near the top of ladders used by firefighters.

2. History of the Prior Art

Firefighters frequently take calculated risks while fighting fires. One such risk involves using ladders to climb to the roof of buildings so that a hole can be cut in the roof to ventilate the fire. Although ventilation of the fire increases the burn rate, it allows the escape of super-heated gasses and smoke, thus improving visibility inside the building. This ventilation procedure greatly improves visibility, air quality, and temperature conditions within burning structures, thereby enabling fire crews to more rapidly and more safely extinguish the fire. One of the reasons that climbing to the roof of buildings involves substantial risk is that smoke may subsequently obscure the top of the ladder used in the ascent. For this reason, and also because fire impingement on the roof structure may make a return to the original roof access point unsafe or impossible, crews routinely set up at least two ladders for roof access. The presence of smoke and darkness, as well as the use of masks that often become fogged can make it difficult for a firefighter to locate his ladder. If he is unable to locate at least one of the ladders for roof egress, he has limited options—all of which are dangerous. The longer he remains on the roof, the greater the possibility that the roof may collapse, or that he may be asphyxiated by the smoke. In order to avoid those risks, he may be tempted to jump to the ground, which is also a potentially life-threatening event.

Many other professions use ladders in low visibility conditions, such as electrical workers, maintenance workers, construction workers, utility/cable company workers, and more.

What is needed is some type of device that will enable workers to more easily locate ladders used for roof access so that they can descend to the ground, without delay, once tasks on the roof have been completed.

### SUMMARY OF THE INVENTION

The present invention fulfills the heretofore expressed need for a device that will enable workers to more easily return to ladders used to access rooftops and other elevated locations during conditions of limited visibility. A light module is provided that incorporates multiple high-intensity light-emitting diodes (LEDs), which are coupled to an electro-chemical power source (battery or single cell). The LEDs may be wired for a continuous “ON” condition, but are preferably connected to flasher circuitry. In order to provide maximum intensity in low-visibility conditions, all LEDs should, preferably, be programmed to flash simultaneously. With the advent of higher intensity LEDs, it may be possible in the future to use a single bright LED in place of multiple LEDs in the flasher unit. The flasher circuitry is designed so that the LEDs flash about one to two times per second. Alternatively, the flasher circuitry may be designed with a unique flash pattern, such as a repeating, several second sequence of multiple flashes in rapid succession, followed by a delay. A first embodiment flasher module is sized to install within the uppermost portion of a ladder rail (i.e., vertical beam) of C-shaped cross section. Although a single module may be used, the use of two first embodiment modules—one module located in each rail—provides viewing over a wider angle. A second embodiment modules incorporates the LEDs within a bar that is mountable beneath the uppermost rung of the ladder. The flasher circuitry and electro-chemical power source may also be located within the bar, or it may be located within a separate module installable within or on the ladder rail. In the latter case, a cable connects the flasher/power module to the bar containing the LEDs. The second embodiment of the invention provides a larger viewing angle, as compared with the first embodiment, which is entirely positioned within the ladder rail. Either embodiment of the invention may be equipped with a gravity-actuated switch, which will turn on the flasher circuitry whenever the ladder is deployed at an angle greater than 45 degrees from horizontal. The switch will deactivate the flasher circuitry whenever the ladders are stored horizontally.

### BRIEF DESCRIPTION OF THE DRAWINGS

FIG. 1 is an isometric view of a disassembled flasher module;

FIG. 2 is an isometric view of the disassembled flasher module without the cover;

FIG. 3 is an isometric view of the assembled flasher module installed within an uppermost portion of a ladder rail;

FIG. 4 is an alternative isometric view of the assembled flasher module installed within an uppermost portion of a ladder rail;

FIG. 5 is an isometric view of a ladder rail and the uppermost rung of the ladder, with the assembled flasher module installed within the ladder rail;

FIG. 6 is a top plan view of the flasher module (the cover removed) with a first set of four of the total eight LEDs illuminated during a flashing sequence;

FIG. 7 is a top plan view of the flasher module (the cover removed) with a second set of four of the eight total LEDs illuminated during a flashing sequence;

FIG. 8 is a top plan view of the assembled flasher module with a second four of the eight LEDs illuminated during a flashing sequence;

FIG. 9 is a rear elevational view of a top portion of a ladder on which is installed a second embodiment high-intensity flasher module;

FIG. 10 is an elevational view of an uninstalled example of the second embodiment high-intensity flasher module;

FIG. 11 is an enlarged cross sectional view through section line 11-11 of FIG. 10; and

FIG. 12 is a block diagram of the circuitry for a generally preferred embodiment of the invention.

### DETAILED DISCLOSURE OF THE INVENTION

The present invention includes several embodiments of a high-intensity LED flasher module designed for installation on an uppermost portion of a ladder. By acting as a locator beacon, the device that will enable workers to more easily return to ladders used for roof or other elevated area access when visibility is hampered by darkness, smoke, or other factors. The invention will now be described in detail with reference to the attached drawings.

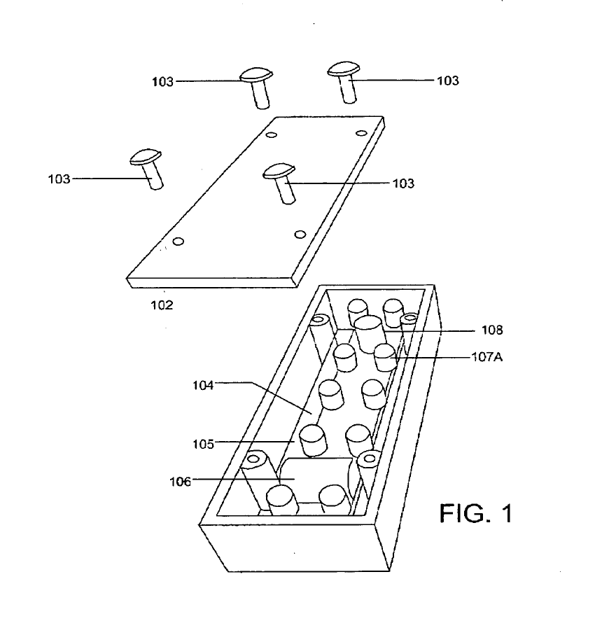

Referring now to FIG. 1, a first embodiment flasher module 100 has been disassembled to show the transparent or translucent cover 101, the bare module 102, and the screws 103A and 103B, which are used to secure the cover 101 to the bare module 102. The bare module 102 comprises a base 104 on which are mounted a circuit board 105 and an electro-chemical power supply 106 (in this case, a single coin cell). The circuit board 105 includes first and second sets of high-intensity white LEDs 107A and 107B, respectively and flasher circuitry 108. Both sets of LEDs 107A and 107B, as well as the flasher circuitry 108 are powered by the electro-chemical power supply 106.

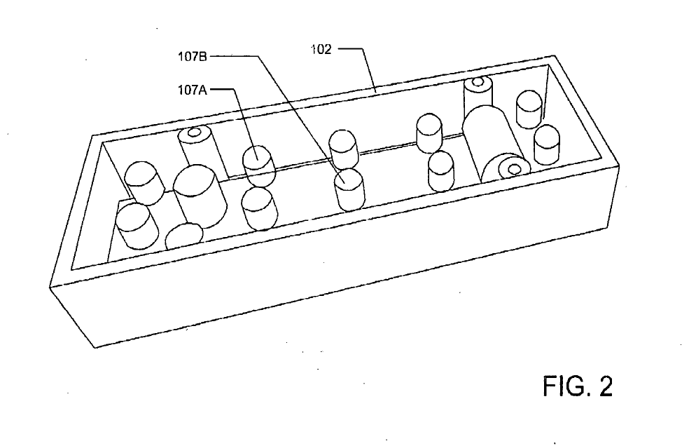

Referring now to FIG. 2, the bare module 102 is shown along with the screws 103A and 103B. Each set of high-intensity white LEDs 107A and 107B is arranged in a linear array.

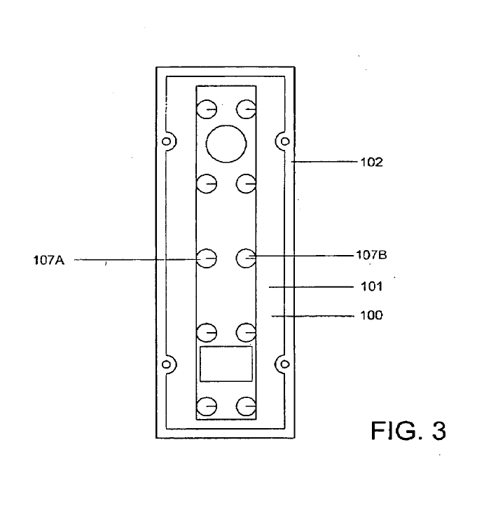

Referring now to FIG. 3, the assembled high-intensity flasher module 100 is shown installed in an uppermost portion of a ladder rail 301. As ladder rail 301 is of C-shaped cross section, both sets of high intensity LEDs 107A and 107B will be visible through the transparent or translucent cover 101. In order to provide an increased viewing angle, a high-intensity flasher module 100 may be installed within the upper ends of both rails of a ladder. The module 100 may be adhesively bonded to the ladder rail with an adhesive that may be solvated when the module 100 must be removed for service. Other means of securing the module 100 to the ladder rail 301, such as screws, cable ties and clamps may also be used.

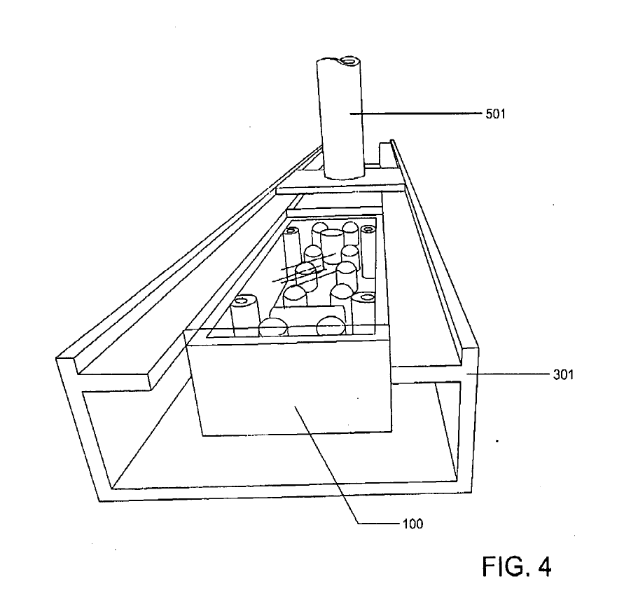

Referring now to FIG. 4, the ladder rail 301 having a high-intensity flasher module 100 installed therein is shown from the upper end thereof.

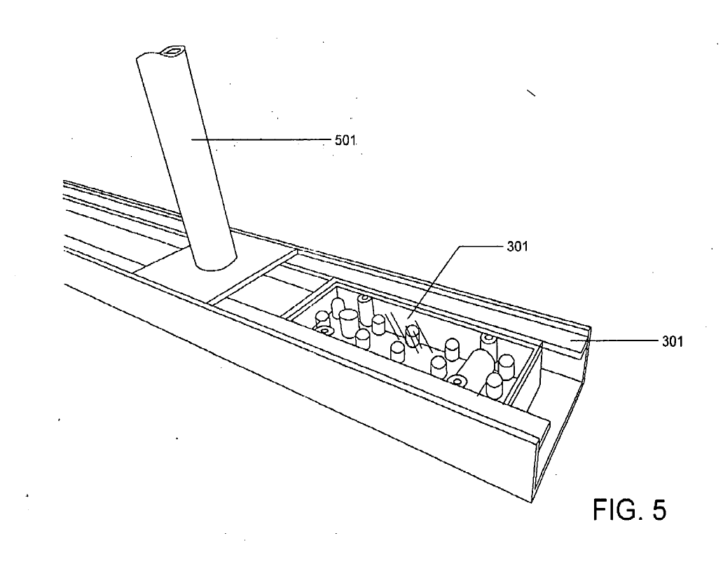

Referring now to FIG. 5, an assembled high-intensity flasher module 100 is shown installed with uppermost portion of a ladder rail 301. The uppermost rung of the ladder 501 is also visible.

Referring now to FIG. 6, a bare high-intensity flasher module 102, having its cover 101 removed, is shown in an operational mode during a flashing sequence. The flasher circuitry 108 is programmed so that each set of four high-intensity LEDs 107A and 107B flashes alternately in sequence. The second set of LEDs 107B is shown illuminated in this view. Although the alternating pattern may help to distinguish the flasher unit and the associated ladder from other flashing lights present during an emergency situation, it has since been determined that all installed LEDs should flash simultaneously in order to provide maximum flash intensity in low-visibility conditions. For a preferred embodiment of the invention, the flasher circuitry is designed so that the LEDs flash about one to two times per second. Alternatively, the flasher circuitry may be designed with a unique flash pattern, such as a repeating, several second sequence of multiple flashes in rapid succession, followed by a delay. A unique flash pattern may help to distinguish the ladder flasher units from other flashing lights.

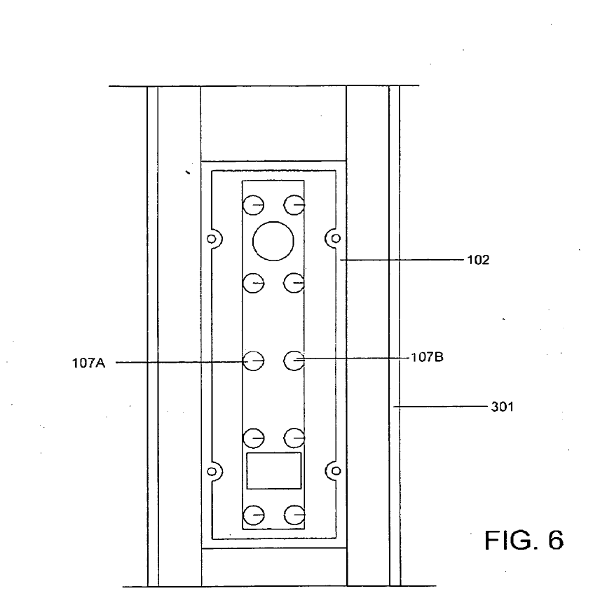

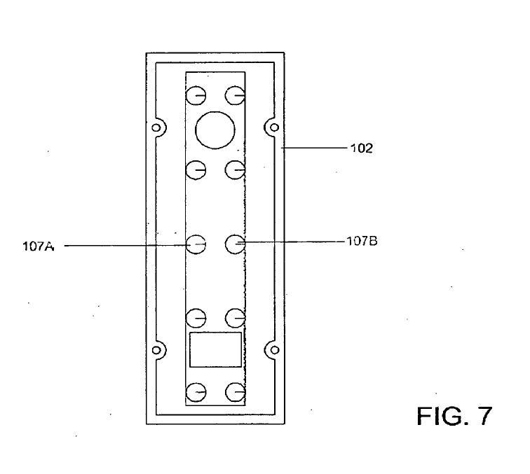

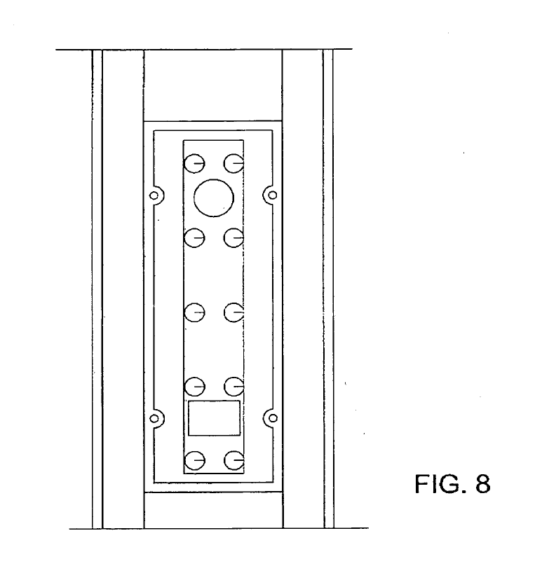

Referring now to FIG. 7, the bare high-intensity flasher module 102 is shown in an operational mode during the same flashing sequence as in FIG. 8, but with the first set of four LEDs 107A illuminated.

Referring now to FIG. 8, the fully-assembled high-intensity flasher module 102 is shown in an operational mode with the first set of four LEDs 107A illuminated.

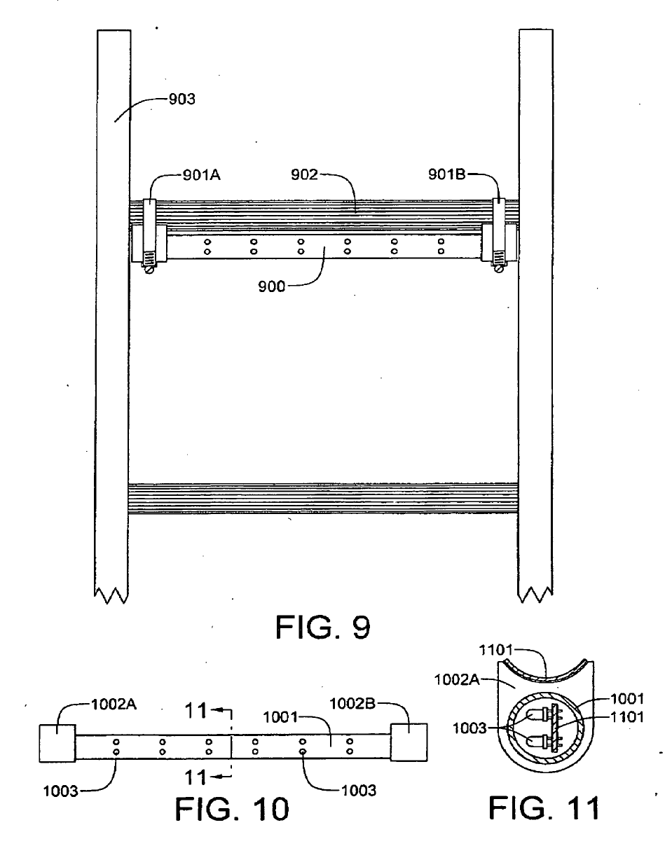

Referring now to FIG. 9, a second embodiment high-intensity flasher module 900 is seen secured with hose clamps 901A and 901B to the uppermost rung 902 of a fire ladder 903.

Referring now to FIG. 10, The second embodiment high-intensity flasher module comprises a hollow, generally transparent plastic tube 1001 and end pieces 1002A and 1002B, which are made of cast or machined aluminum, stainless steel, or a structural injection-molded polymer resin, which may be optionally reinforced with structural fibers, such as fiberglass, aramid fibers, or graphite. Each of the end pieces 1002A and 1002B has a socket which receives an end of the plastic tube 1001. The high-intensity LEDs 1003 are encased within the plastic tube 1001, as are circuit components and an electro-chemical power supply. For a preferred embodiment of the invention, the plastic tube 1001 is made of a tough generally transparent plastic material, such as polycarbonate plastic.

Referring now to FIG. 11, this cross-sectional view shows end piece 1002A, a resilient pad 1101 that is compressed between the end piece 1002 and the ladder rung 902 to which it is installed. Also shown within the polycarbonate tube 1001 are a circuit board and a pair of high-intensity LEDs 1003. The electro-chemical power supply and flasher circuitry (neither of which are shown in this view) are also enclosed within the polycarbonate tube 1001. An external switch, placed in a convenient location on the device, allows power and the flashing function to be enabled or disabled.

Either embodiment of the invention may be equipped with a gravity-actuated switch, which will turn on the flasher circuitry whenever the ladder is deployed in at a nearly-vertical angle. The switch will deactivate the flasher circuitry whenever the ladders are stored horizontally. Mercury switches, which are well known in the art for their effectiveness and reliability. Except for the harmful environmental aspects from the use of mercury, these switches are ideal for this application. Over the past thirty of so years, mechanical substitutes for mercury switches have been developed. U.S. Pat. Nos. 4,513,183; 6,603,084; 5,767,467; 4,668,846; and 4,427,876 disclose mechanical gravity switches which may be substituted for mercury switches.

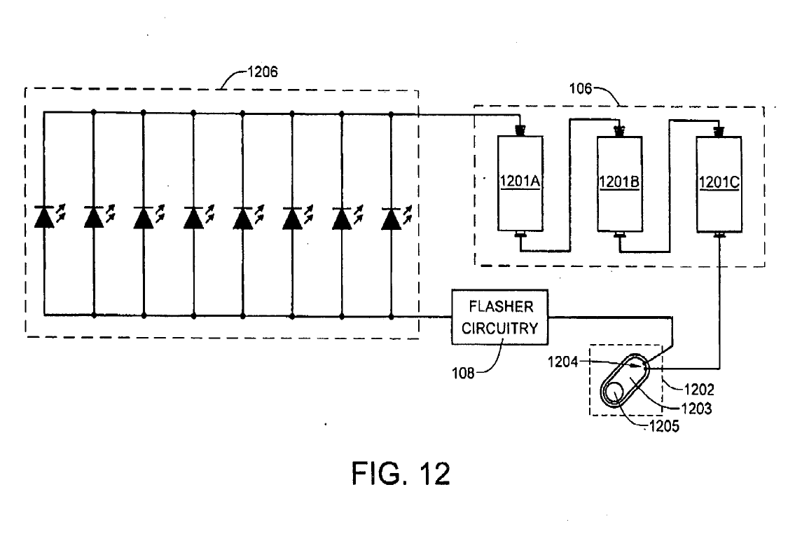

Referring now to FIG. 12, the block diagram of circuitry for a generally preferred embodiment of the invention includes an electro-chemical power supply 106 consisting of three 1.5-volt cells 1201A, 1201B and 1201C. A mercury switch 1202 includes a glass capsule 1203 having contacts 1204 at an upper end thereof and a ball of liquid mercury metal 1205 that bridges the contacts 1204 when the switch 1202 is tilted so that the ball of mercury metal 1205 rolls toward the contacts. The configuration of the switch approximates its installation tilt on a ladder when in a horizontal position.

Although only several embodiments of the present invention have been disclosed herein, it will be obvious to those having ordinary skill in the art that changes and modifications may be made thereto without departing from the scope and spirit of the invention as hereinafter claimed.

What is claimed is:

1. A flasher module, installable on an extension ladder, comprising:
a housing sized for installation adjacent an upper rung of the ladder, said housing having a generally transparent portion;
an electro-chemical power source installed within said housing;
flasher circuitry installed within said housing and powered by said electro-chemical power source;
at least one light-emitting diode installed within said housing behind said transparent portion and coupled to said electro-chemical power source through said flasher circuitry; and
a gravity switch installed within said housing, which connects power to said flasher circuitry and said at least one light-emitting diode when the extension ladder is elevated to an angle greater than about 45 degrees from horizontal.

2. The flasher module of claim 1, wherein all light-emitting diodes within the module flash simultaneously.

3. The flasher module of claim 2, wherein said flasher circuitry is programmed to flash all light-emitting diodes within the module in a recognizable sequence.

4. The flasher module of claim 1, wherein said housing is shaped to slide into an uppermost portion of an extension ladder rail to which it is subsequently secured.

5. The flasher module of claim 1, wherein said housing comprises a generally transparent cylindrical tube and a pair of end pieces, each of which caps an end of the cylindrical tube and is securable to a lower surface of a ladder rung, each of said end pieces being adjacent a rail of the extension ladder.

6. The flasher module of claim 5, wherein said generally transparent cylindrical tube is made of polycarbonate thermoplastic resin.

7. The flasher module of claim 5, wherein each end piece is made of a solid material selected from the group consisting of stainless steel, aluminum alloys, structural thermoplastic resins, fiberglass-reinforced structural thermoplastic resin, aramid-fiber-reinforced structural thermoplastic resin, and graphite-reinforced structural thermoplastic resin.

8. The flasher module of claim 5, wherein each end piece is shaped to conform to the ladder rail to which it is secured.

9. The flasher module of claim 8, wherein each end piece is secured to the ladder rail with clamps.

10. The flasher module of claim 4, which further comprises an identical flasher module installed and secured within an upper portion of an opposite rail of the extension ladder.

11. A flasher module, installable on an extension ladder, comprising:
an elongated watertight housing which spans a major portion of a length of an upper rung of the extension ladder, said housing having a generally transparent tube and a pair of end pieces, each of which caps an end of the generally transparent tube and is securable to a lower surface of a ladder rung, each of said end pieces being adjacent a rail of the extension ladder;
an electro-chemical power source installed within said housing;
flasher circuitry installed within said housing and powered by said electro-chemical power source;
at least one light-emitting diode installed within said generally transparent tube, and coupled to said electro-chemical power source through said flasher circuitry; and
a gravity switch installed within said housing, which connects power to said flasher circuitry and said at least one light-emitting diode when the extension ladder is elevated to an angle greater than about 45 degrees from horizontal.

12. The flasher module of claim 11, wherein said generally transparent tube is cylindrically shaped.

13. The flasher module of claim 11, wherein all light-emitting diodes are wired to flash simultaneously.

14. The flasher module of claim 11, wherein said generally transparent tube is made of polycarbonate thermoplastic resin.

15. The flasher module of claim 11, wherein each end piece is made of a solid material selected from the group consisting of stainless steel, aluminum alloys, structural thermoplastic resins, fiberglass-reinforced structural thermoplastic resins, aramid-fiber-reinforced structural thermoplastic resins, and graphite-reinforced structural thermoplastic resins.

16. The flasher module of claim 11, wherein each end piece is shaped to conform to the ladder rail to which it is secured.

17. The flasher module of claim 11, wherein each end piece is secured to the ladder rail with clamps.

18. A flasher module system, installable on an extension ladder, comprising:
a pair of housings, each of which is shaped and sized to slide into an uppermost portion of an extension ladder rail to which it is subsequently secured, each housing installed separately in one rail of the extension ladder opposite the other rail;
an electro-chemical power source installed within each of said housings;
flasher circuitry installed within each of said housings and powered by the electro-chemical power source resident in the housing;
at least one light-emitting diode installed within said housing behind said transparent portion and coupled to said electro-chemical power source through said flasher circuitry; and
a gravity switch installed within said housing, which connects power to said flasher circuitry and said at least one light-emitting diode when the extension ladder is elevated to an angle greater than about 45 degrees from horizontal.

19. The flasher module of claim 18, wherein all light-emitting diodes within the module flash simultaneously.

20. The flasher module of claim 19, wherein said flasher circuitry is programmed to flash all light-emitting diodes within the module in a recognizable sequence.
